(19) United States
(12) Patent Application Publication
(10) Pub. No.: US 2009/0103010 A1
(43) Pub. Date: Apr. 23, 2009

(54) Liquid crystal display device and manufacturing method thereof

(75) Inventors: Masataka Okamoto, Chonan (JP); Shigeru Matsuyama, Mobara (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 12/285,996

(22) Filed: Oct. 17, 2008

(30) Foreign Application Priority Data
Oct. 17, 2007 (JP) 2007-270089

(51) Int. Cl. G02F 1/1343; G02F 1/1333

(52) U.S. Cl. 349/73; 349/187

(57) ABSTRACT

To provide a liquid crystal display device and a manufacturing method thereof having high quality and high reliability by reducing damages to a connection terminal portion due to laser light when performing cutting of a substrate of a liquid crystal display panel using a plastic substrate at the connection terminal portion by irradiating laser light. In a liquid crystal display device in which a first light-transmissive substrate is opposite to a second light-transmissive substrate in which plural electrodes are formed on an inner surface and a connection terminal portion to the electrodes is formed by being drawn at an end portion, and liquid crystal is sealed in an area circumferential portions of which are surrounded by a sealant, a metal film reflecting laser light is formed on the inner surface of the first light-transmissive substrate opposite to the connection terminal portion, thereby blocking the irradiation of laser light to the connection terminal portion at the time of cutting by the irradiation of laser light.

The present application claims priority from Japanese applications JP2007-270089 filed on Oct. 17, 2007, the content of which is hereby incorporated by reference into this application.

### BACKGROUND OF THE INVENTION

1. Field of the Invention

The invention relates to a liquid crystal display device and a manufacturing method thereof, particularly, relates to a dividing structure of a liquid crystal display device and a dividing method thereof, which is formed by cutting out each liquid crystal display panel to be divided after plural number of liquid crystal display panels are formed on a large-sized mother substrate.

2. Description of the Related Art

In recent years, the demand for flexibility of the liquid crystal display device is increasing, and in response to the demand, the development of a plastic substrate as a flexible base material is proceeding. A so-called multiple-taking method is applied to manufacture of an existing liquid crystal display device, in which a thin-film transistor (TFT) substrate formed by using glass as a base material and attaching plural liquid crystal display panels on a piece of mother substrate (large-sized substrate, large substrate) and a large-sized color filter (CF) substrate formed by attaching plural liquid crystal display panels thereon in the same manner are stacked and bonded with each other, then, the stacked large substrate is cut to obtain respective liquid crystal display panels.

Here, since the liquid crystal display panel attached on the TFT substrate includes a wiring electrode portion, namely, a connecting terminal portion for electrically connecting to an external power source, it is necessary to remove a portion opposite to the connection terminal portion without damaging the connection terminal portion in the cutting of the CF substrate in the above cutting.

For this purpose, in the cutting of the liquid crystal display panel using the glass base material, a method called as a scribe cut using high toughness of glass has been used, in which the reverse surface side of glass is scribed, and power is added to the substrate so that tensile stress acts on the scribe traces to allow the traces to develop in a vertical direction with respect to the substrate surface to cut the substrate. However, it is difficult to apply the scribe cut method to a plastic base material having excellent flexibility, that is, having characteristics of low toughness as compared with glass, and development of an alternative cutting method is required.

### SUMMARY OF THE INVENTION

There exists a method of using irradiation of laser light as an alternative of the scribe cut method. The cutting of the plastic base material by the irradiation of laser light has already been in practical use concerning a single substrate. Also in the structure in which two substrates of the TFF substrate and the CF substrate are stacked to each other such as the liquid crystal display device, it is proven that the cutting of both substrates at the same position is possible as well as the single substrate cutting by adjusting conditions such as the focus depth of laser light, irradiation power and movement speed of light.

However, in the case of the above-described cutting at the connection terminal portion, that is, when only the opposite CF substrate is cut, there is a problem that wiring electrodes provided in the connection terminal portion are damaged due to the transmittance of laser light.

Accordingly, the invention has been made for solving the above conventional problem, and an object thereof is to provide a liquid crystal display device and a manufacturing method thereof which can improve quality and reliability by reducing damages to the connection terminal portion by irradiation of laser light when cutting the substrate at the connection terminal portion of the liquid crystal display panel using the plastic substrate by irradiating laser light.

In order to achieve the above object, in a liquid crystal display device according to the invention in which a first light-transmissive substrate is opposite to a second light-transmissive substrate in which plural electrodes are formed on an inner surface and connection terminal portion connected to the electrodes is formed by being drawn at an end portion, and liquid crystal is sealed in an area circumferential portions of which are surrounded by a sealant, a metal film reflecting laser light is formed on the inner surface of the first light-transmissive substrate opposite to the connection terminal portion, thereby blocking the irradiation of laser light to the connection terminal portion at the cutting by the irradiation of laser light, as a result, the problem in the related art can be solved.

In a manufacturing method of a liquid crystal display device according to the invention in which a first light-transmissive substrate is opposite to a second light-transmissive substrate in which plural electrodes are formed on an inner surface and a connection terminal portion connected to the electrodes is formed by being drawn at an end portion, and liquid crystal is sealed in an area circumferential portions of which are surrounded by a sealant, after forming a metal film reflecting laser light on the inner surface of the first light-transmissive substrate opposite to the connection terminal portion, the first light-transmissive substrate is cut by irradiating laser light along an area of the film width of the metal film from the outside of the first light-transmissive substrate, thereby preventing transmission of laser light in the connection terminal portion at the time of cutting by the irradiation of laser light, as a result, the problem in the related art can be solved.

The invention is not limited to the above structure and structures of later-described embodiments and can be variously modified within a scope not departing from the technical thought of the invention.

According to the invention, the irradiation of laser light to the connection terminal portion formed at the end portion of the second light-transmissive substrate is blocked by the metal film, thereby reducing damages to the connection terminal portion as well as preventing damages of wiring electrodes, as a result, an extremely excellent advantage which can realize a liquid crystal display device having high quality and high reliability.

### BRIEF DESCRIPTION OF THE DRAWINGS

FIG. 1A and FIG. 1B are schematic views explaining a structure of a liquid crystal display panel for explaining Embodiment 1 of a liquid crystal display device according to the invention, in which FIG. 1A is a plan view seen from the above and FIG. 1B is a plan view seen from the side;

FIG. 2 is an enlarged cross-sectional view taken along A-A line of FIG. 1A;

FIG. 3A to FIG. 3C are schematic views when a plurality of liquid crystal display panels of FIG. 1A and FIG. 1B are attached on the substrate for explaining an embodiment of a manufacturing method of an liquid crystal display device according to the invention, in which FIG. 3A is a plan view seen from the above, FIG. 3B is a plan view seen from the side and FIG. 3C is a plan view seen from below;

FIG. 4A and FIG. 4B are views explaining the manufacturing method of the liquid crystal display device shown in FIG. 3A to FIG. 3C, in which FIG. 4A is a plan view seen from the above and FIG. 4B is a plan view seen from the side; and

FIG. 5 is an enlarged cross-sectional view taken along A-A line of FIG. 4A.

### DESCRIPTION OF THE PREFERRED EMBODIMENTS

Hereinafter, specific embodiments of the invention will be explained in detail with reference to drawings for the embodiments.

### Embodiment 1

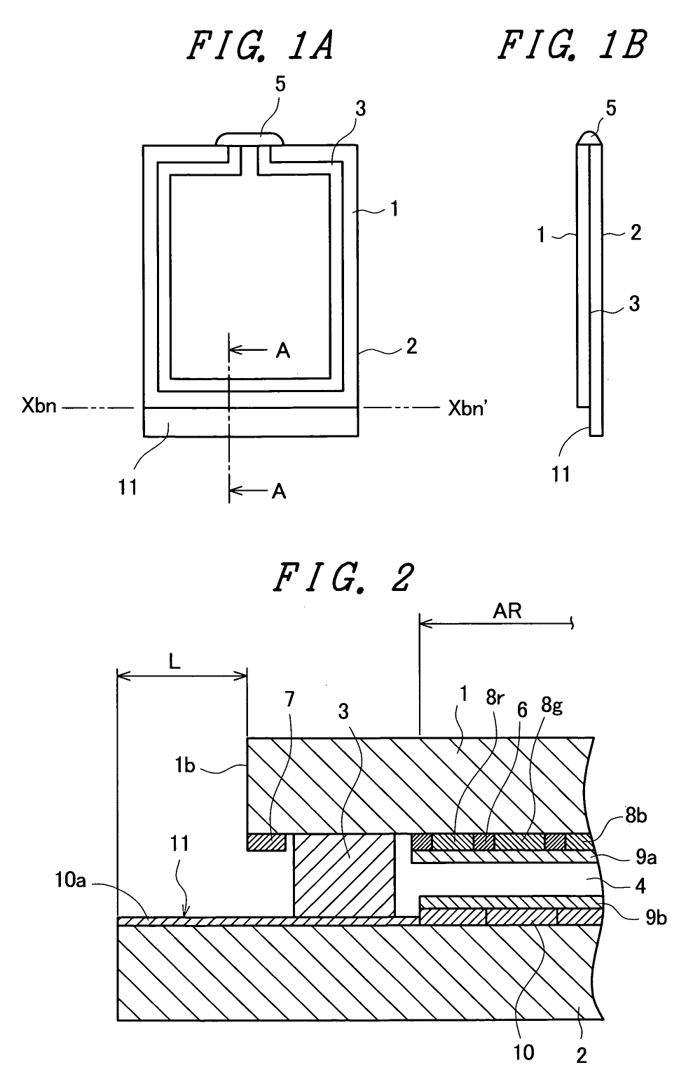

FIG. 1A and FIG. 1B are schematic views explaining a structure of a liquid crystal display panel for explaining Embodiment 1 of a liquid crystal display device according to the invention, in which FIG. 1A is a plan view seen from the above and FIG. 1B is a plan view seen from the side. FIG. 2 is an enlarged cross-sectional view taken along A-A line of FIG. 1A.

In FIG. 1A, FIG. 1B and FIG. 2, the liquid crystal display panel has a structure in which a light-transmissive plastic substrate (also referred to as a color filter substrate and a CF substrate) 1 as a first light-transmissive substrate having a thickness of 0.2 mm, in which plural pixels are formed on an inner surface and at least one electrode is formed is opposite to a light-transmissive plastic substrate (also referred to as a thin-film transistor substrate or a TFT substrate) 2 as a second light-transmissive substrate having a thickness of approximately 0.2 mm, in which plural electrodes and the like are formed on an inner surface at an area opposite to the plural pixels and electrode terminals 10a connected to the electrodes are formed at an end portion of the substrate, a liquid crystal 4 is filled from a liquid crystal filling port into an area surrounded by a frame-shaped sealant 3 at opposite circumferential portions and sealed by an end sealant 5. A gap between the plastic substrate 1 and the plastic substrate 2 is approximately 4 μm.

On an inner surface of a display area AR of the plastic substrate 1, a black matrix film 6 formed by, for example, coating a black resin material in which carbon is scattered in an acrylate resin in a prescribed matrix pattern is deposited. Further, on an inner surface of a short-edge side end portion of the plastic substrate 1, a band-shaped metal film 7 having a prescribed film width and film thickness along a longitudinal direction of the short edge is deposited. The metal film 7 is formed by, for example, a deposited film of Al₂O₃ material, which reflects laser light.

The metal film 7 is formed at an end portion of the inner surface which is opposite to a surface on which a later-described connection terminal portion is formed in the plastic substrate 2, having a function of reflecting laser light so as not to be irradiated to the connection terminal portion of the plastic substrate 2 when respective liquid crystal display panels are cut out from one large substrate by irradiating laser light to cutting lines of plural liquid crystal display panels attached on the substrate. It is also preferable that the metal film 7 is formed by being coated by the same material instead of Al₂O₃ and in the same process as the black matrix film 6 to be a laser light absorbing film, thereby absorbing irradiated laser light so that the laser light is not irradiated to the connection terminal portion of the plastic substrate 2. In this case, it is desirable to use, for example, a Cr metal as a material of the black matrix film 6 and the metal film 7 for satisfying the light blocking effect for laser light.

In the matrix pattern of the black matrix film 6 formed in the display area AR, respective color filters 8r, 8g and 8b of red, green and blue are formed in a prescribed arrangement respectively as shown in FIG. 2. In addition, over the surface on which the black matrix film 6 and respective color filters 8r, 8g and 8b are formed, an overcoat film made of a light-transmissive acrylate resin material and a common electrode made of ITO are formed though not shown. An alignment film 9a made of a polyimide material is further formed thereunder.

On an inner surface of the plastic substrate 2 arranged opposite to the plastic substrate 1, pixels 10 each having a pixel electrode made of ITO and the like and a thin-film transistor as a switching element for selecting pixels and the like are arranged in a matrix form. As a configuration of each pixel 10, a protection film made of, for example, silicon oxide or silicon nitride is arranged on the thin-film transistor, a pixel electrode made of, for example, an ITO electrode and an alignment film 9b made of, for example, polyimide is further formed thereon.

One short-edge side end portion of the plastic substrate 2 is formed so as to opposite to the short-edge side end portion of the plastic substrate 1 in which the metal film 7 is formed, extending from a cut surface 1b of the plastic substrate 1 for the length L toward the outside direction. In other words, the short-edge side end portion of the plastic substrate 1 is formed so as to be shorter than the short-edge side end portion of the plastic substrate 2 by the length L. Additionally, at the end surface 1b at the short-edge side of the plastic substrate 1, laser traces having vertical stripes formed by being cut by the irradiation of laser light are formed.

On an upper surface of the short-edge side end portion of the plastic substrate 2, plural electrode wirings 10a connected to respective pixel electrodes formed in the active display area AR are drawn out to form a connection terminal portion 11 to be connected to an external drive circuit. Accordingly, the connection terminal portion 11 formed at the short-edge side end portion of the plastic substrate 2 is formed so as to have a positional relation in which the connection terminal portion 11 is arranged opposite to the metal film 7 formed in the short-edge side end portion of the plastic substrate 1.

As shown in Embodiment 1, the metal film or the laser light absorbing film is provided, thereby blocking the irradiation of laser light to the connection terminal portion formed at the end portion of the second light-transmissive substrate, therefore, damages to the connection terminal portion can be reduced and damages to the wiring electrodes can be prevented, as a result, a liquid crystal display device having high quality and high reliability can be realized.

### Embodiment 2

Next, a manufacturing method of the liquid crystal display device formed as the above will be explained as Embodiment 2 of the invention with reference to the drawings.

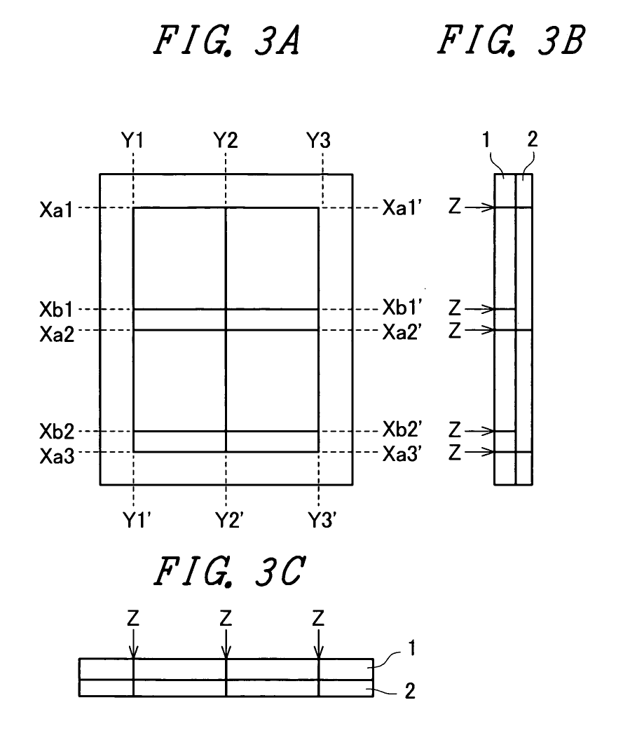

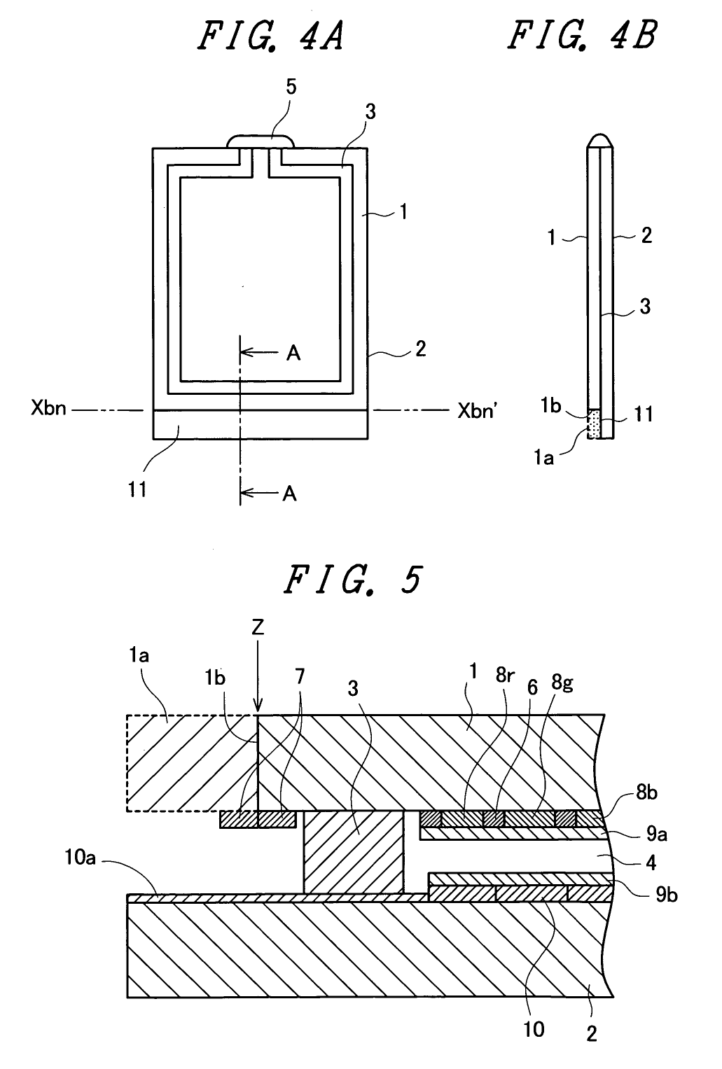

FIG. 3A to FIG. 3C are schematic views when a plurality of liquid crystal display panels shown in FIG. 1A and FIG. 1B are attached on the substrate, in which FIG. 3A is a plan view seen from the above, FIG. 3B is a plan view seen from the side and FIG. 3C is a plan view seen from below, FIG. 4A and FIG. 4B are views explaining the manufacturing method of the liquid crystal display device shown in FIG. 3A to FIG. 3C, in which FIG. 4A is a plan view seen from the above and FIG. 4B is a plan view seen from the side. FIG. 5 is an enlarged cross-sectional view taken along A-A line of FIG. 4A.

First, in FIG. 3A to FIG. 3C, four liquid crystal display panels as shown FIG. 1 are attached on a large-sized mother substrate having the size of 150 mm×150 mm square and liquid crystal is sealed in a gap surrounded by a sealant 3. Then, cutting is performed by irradiating laser light along cutting lines to obtain four liquid crystal display panels. In the cutting of the process, a DUV laser light having a wavelength of approximately 266 nm is used. The laser light is irradiated from the above of the plastic substrate 1 in the Z direction shown by arrows, while reciprocating on respective cutting lines Yn-Yn′, Xan-Xan′, and Xbn-Xbn′.

At this time, the cutting at the cutting line Yn-Yn′ and the cutting line Xan-Xan′ are performed at the same positions of the stacked two substrates (the plastic substrate 1 and the plastic substrate 2), however, in the cutting of the cutting line Xbn-Xbn′, only the plastic substrate 1 is cut for leaving the opposite connection terminal portion 11 as shown in FIG. 4A and FIG. 4B, in which the problem of damaging the connection terminal portion 11 by the laser light occurs as described above.

The embodiment has a structure in which the metal film 7 made of a deposited film of Al₂O₃ material having the size larger than a width or a diameter (approximately 3 μm) of laser light, for example, a film width of approximately 0.4 mm to 1.0 mm, a film thickness of approximately 500 nm to 700 nm when taking the cutting line Xbn-Xbn′ as the center is formed along the cutting line Xbn-Xbn′ on the inner surface of the short-edge side of the plastic substrate 1 as shown in the enlarged cross-sectional view of FIG. 5, which is taken along A-A line of FIG. 4, in order to solve the problem.

Then, laser light is irradiated to the metal film 7 deposited at the end portion of the plastic substrate 1 in the Z direction from the above of the plastic substrate 1 along the cutting line of the longitudinal direction, thereby cutting off a cutoff portion la on which a portion of the metal film 7 is deposited as shown in FIG. 4B as well as laser traces having vertical stripes by the irradiation of laser light are formed at the cutoff surface 1b.

According to the manufacturing method, the irradiation of laser light at the time of cutting of the plastic substrate 1 cuts only the substrate body and laser light irradiated on the metal film 7 is reflected, therefore, laser light does not reach the connection terminal portion 11 formed at the end portion of the plastic substrate 2, as a result, damages caused by laser irradiation are not given to the connection terminal portion 11 and a damage prevention structure for the connection terminal portion 11 can be easily realized.

In the above embodiments, the case in which the first light-transmissive substrate and the second light-transmissive substrate use the plastic substrate made of a plastic base material has been explained, however, the invention is not limited to this, and it is preferable that the light-transmissive glass substrate is used for the first light-transmissive substrate and the light-transmissive plastic substrate is used for the second light-transmissive substrate and it is also preferable that the light-transmissive plastic substrate is used for the first light-transmissive substrate and the light-transmissive glass substrate is used for the second light-transmissive substrate, and further, when the light-transmissive glass substrate is used for both the first light-transmissive substrate and the second light-transmissive substrate, the same advantages as the above case can be obtained.

In the above embodiments, the structure of the liquid crystal display device has been explained, however, the invention is not limited to this, and it goes without saying that the same advantages can be obtained when the invention is applied to the structure of an organic EL display device.

What is claimed is:

1. A liquid crystal display device in which a first light-transmissive substrate is opposite to a second light-transmissive substrate in which plural electrodes are formed on an inner surface and a connection terminal portion connected to the electrodes is formed by being drawn at an end portion, and liquid crystal is sealed in an area circumferential portions of which are surrounded by a sealant, wherein:
a metal film reflecting laser light is formed on the inner surface of the first light-transmissive substrate opposite to the connection terminal portion.

2. The liquid crystal display device according to claim 1,
wherein the length from an end surface on which the metal film is formed to the sealant in the first light-transmissive substrate is shorter than the length from an end surface on which the connection terminal portion is formed to the sealant in the opposite second light-transmissive substrate.

3. The liquid crystal display device according to claim 1,
wherein the first light-transmissive substrate and the second light-transmissive substrate are made of a plastic base material.

4. The liquid crystal display device according to claim 1,
wherein the metal film is formed continuously along only a cutting line portion of the first light-transmissive substrate.

5. The liquid crystal display device according to claim 1,
wherein cutting traces due to the irradiation of laser light are formed at an end surface of the first light-transmissive substrate which is opposite to the connection terminal portion.

6. A manufacturing method of a liquid crystal display device in which a first light-transmissive substrate is opposite to a second light-transmissive substrate in which plural electrodes are formed on an inner surface and a connection terminal portion connected to the electrodes is formed by being drawn at an end portion, and liquid crystal is sealed in an area circumferential portions of which are surrounded by a sealant, comprising the steps of:
forming a metal film reflecting laser light on the inner surface of the first light-transmissive substrate opposite to the connection terminal portion;
irradiating laser light from the outside of the first light-transmissive substrate along an area within a film width of the metal film; and
cutting an end portion of the first light-transmissive substrate.

7. The manufacturing method of the liquid crystal display device according to claim 6,
wherein the first light-transmissive substrate and the second light-transmissive substrate are made of a plastic base material.

8. The manufacturing method of the liquid crystal display device according to claim 6,
wherein the metal film is formed continuously along only a cutting line portion of the first light-transmissive substrate.

9. The manufacturing method of the liquid crystal display device according to claim 6,
wherein the film width of the metal film is larger than a width or a diameter of the laser light.
